(19) United States
(12) Patent Application Publication
(10) Pub. No.: US 2017/0053621 A1
(43) Pub. Date: Feb. 23, 2017

(54) Roundtrip Reintegration of Asynchronous 3D Session

(71) Applicant: Microsoft Technology Licensing, LLC, Redmond, WA (US)

(72) Inventors: Henry Yao-Tsu Chen, Woodinville, WA (US); Brandon V. Taylor, Mercer Island, WA (US); Mark Robert Swift, Mercer Island, WA (US); Austin S. Lee, Pittsburgh, PA (US); Ryan S. Menezes, Woodinville, WA (US)

(73) Assignee: Microsoft Technology Licensing, LLC, Redmond, WA (US)

(21) Appl. No.: 15/141,666

(22) Filed: Apr. 28, 2016

Related U.S. Application Data
(60) Provisional application No. 62/207,732, filed on Aug. 20, 2015.

(51) Int. Cl. G09G 5/377; G06F 3/14; G06F 3/0481; G06F 17/24; G06T 19/00

(52) U.S. Cl. CPC G09G 5/377; G06F 17/241; G06T 19/006; G06F 3/04815; G06F 3/1454; G09G 2370/02; G06T 2219/024

(57) ABSTRACT

A user device within a communication architecture, the user device comprising a session viewer configured to: receive at least one annotation object associated with a mixed reality/virtual reality session; determine a field of view position; and generate an image overlay based on the determined field of view position and at least one annotation object to display an indicator to guide a user of the user device to a representation of the annotation object.

### PRIORITY

This application claims priority to U.S. Provisional Application Ser. No. 62/207,732 entitled “Roundtrip Reintegration of Asynchronous 3D Session into Hololens Space” and filed Aug. 20, 2015, the disclosure of which is incorporated by reference herein its entirety.

### BACKGROUND

Communication systems allow the user of a device, such as a personal computer, to communicate across the computer network. For example using a packet protocol such as Internet Protocol (IP) a packet-based communication system may be used for various types of communication events. Communication events which can be established include voice calls, video calls, instant messaging, voice mail, file transfer and others. These systems are beneficial to the user as they are often of significantly lower cost than fixed line or mobile networks. This may particularly be the case for long-distance communication. To use a packet-based system, the user installs and executes client software on their device. The client software provides the packet-based connections as well as other functions such as registration and authentication.

Communications systems allow users of devices to communicate across a computer network such as the internet. Communication events which can be established include voice calls, video calls, instant messaging, voice mail, file transfer and others. With video calling, the callers are able to view video images.

However in some circumstances the communication may be stored rather than transmitted in (near) real time and be received by the end user at a later time.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Nor is the claimed subject matter limited to implementations that solve any or all of the disadvantages noted in the background section.

Embodiments of the present disclosure relate to management and synchronisation of objects within a shared scene, such as generated in collaborative mixed reality applications. In collaborative mixed reality applications, participants can visualize, place, and interact with objects in a shared scene. The shared scene is typically a representation of the surrounding space of one of the participants, for example the scene may include video images from the viewpoint of one of the participants. An object or virtual object can be ‘placed’ within the scene and may have a visual representation which can be ‘seen’ and interacted with by the participants. Furthermore the object can have associated content. For example the object may have associated content such as audio/video or text. A participant may, for example, place a video player object in a shared scene, and interact with it to start playing a video for all participants to watch. Another participant may then interact with the video player object to control the playback or to change its position in the scene.

The inventors have recognised that in order to maintain the synchronisation of these objects within the scheme the efficient transfer of surface recreation data (also known as mesh data) may be significant.

According to first aspect of the present disclosure there is provided a user device within a communication architecture, the user device comprising a session viewer configured to: receive at least one annotation object associated with a mixed reality/virtual reality session; determine a field of view position; and generate an image overlay based on the determined field of view position and at least one annotation object to display an indicator to guide a user of the user device to a representation of the annotation object.

According to another aspect of the present disclosure there is provided a method implemented within a communication architecture, the method comprising: receiving at least one annotation object associated with a mixed reality/virtual reality session; determining a field of view position; and generating an image overlay based on the determined field of view position and at least one annotation object to display an indicator to guide a user of the user device to a representation of the annotation object.

According to another aspect of the present disclosure there is provided a computer program product, the computer program product being embodied on a non-transient computer-readable medium and configured so as when executed on a processor of a protocol endpoint entity within a communication architecture, to: receive at least one annotation object associated with a mixed reality/virtual reality session; determine a field of view position; and generate an image overlay based on the determined field of view position and at least one annotation object to display an indicator to guide a user of the user device to a representation of the annotation object.

### BRIEF DESCRIPTION OF THE DRAWINGS

For a better understanding of the present disclosure and to show how the same may be put into effect, reference will now be made, by way of example, to the following drawings in which:

FIG. 1 shows a schematic view of a communication system;

FIG. 2 shows a schematic view of a user device;

FIG. 3 shows a schematic view of a user device as a wearable headset;

FIG. 4 show a schematic view of example user devices suitable for implementing for an asynchronous session;

FIG. 5 shows a schematic view of asynchronous session generation implementation and asynchronous session review implementation examples;

FIG. 6 shows a schematic view of the example asynchronous session review implantation user interface for adding, editing and deleting annotation objects as shown in FIG. 5;

FIG. 7 shows a flow chart for a process of generating asynchronous session data according to some embodiments;

FIG. 8 shows a flow chart for a process of reviewing asynchronous session data to generate or amend an annotation object according to some embodiments;

FIG. 9 shows a flow chart for processes of navigating the asynchronous session data within an asynchronous session reviewing process to generate, amend or delete an annotation object as shown in FIG. 8 according to some embodiments;

FIG. 10 shows a flow chart for a process of reviewing the asynchronous session data to present an annotation object according to some embodiments;

FIG. 11 shows a flow chart for a process of reviewing the asynchronous session data to selectively present an annotation object according to some embodiments; and

FIG. 12 shows a flow chart for a process of reviewing the asynchronous session data to guide a user to the annotation object according to some embodiments.

### DETAILED DESCRIPTION

Embodiments of the present disclosure are described by way of example only.

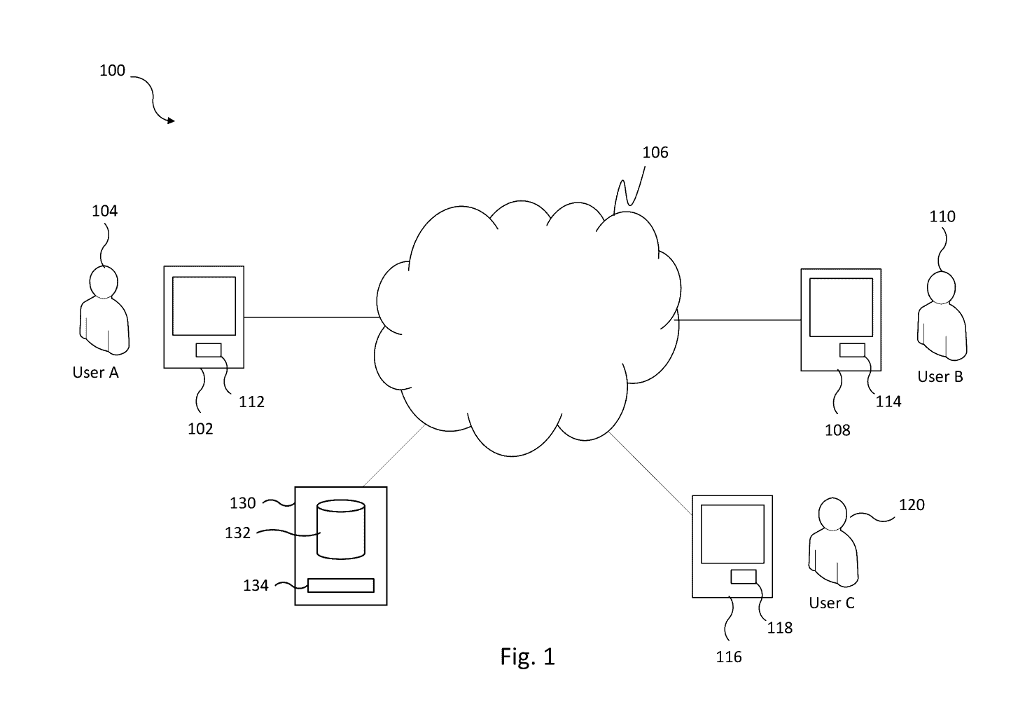

FIG. 1 shows a communication system 100 suitable for implementing an asynchronous session. The communication system 100 is shown comprising a first user 104 (User A) who is associated with a user terminal or device 102, a second user 110 (User B) who is associated with a second user terminal or device 108, and a third user 120 (User C) who is associated with a third user terminal or device 116. The user devices 102, 108, and 116 can communicate over a communication network 106 in the communication system 100 via a synchronization device 130, thereby allowing the users 104, 110, and 120 to asynchronously communicate with each other over the communication network 106. The communication network 106 may be any suitable network which has the ability to provide a communication channel between the user device 102, the second user device 108, and the third user device 116. For example, the communication network 106 may be the Internet or another type of network such as a high data rate cellular or mobile network, such as a 3^{rd} generation (“3G”) mobile network.

Note that in alternative embodiments, user devices can connect to the communication network 106 via an additional intermediate network not shown in FIG. 1. For example, if the user device 102 is a mobile device, then it can connect to the communication network 106 via a cellular or mobile network (not shown in FIG. 1), for example a GSM, UMTS, 4G or the like network.

The user devices 102, 108 and 116 may be any suitable device and may for example, be a mobile phone, a personal digital assistant (“PDA”), a personal computer (“PC”) (including, for example, Windows™, Mac OS™ and Linux™ PCs), a tablet computer, a gaming device, a wearable device or other embedded device able to connect to the communication network 106. The wearable device may comprise a wearable headset.

It should be appreciated that one or more of the user devices may be provided by a single device. One or more of the user devices may be provided by two or more devices which cooperate to provide the user device or terminal.

The user device 102 is arranged to receive information from and output information to User A 104.

The user device 102 executes a communication client application 112, provided by a software provider associated with the communication system 100. The communication client application 112 is a software program executed on a local processor in the user device 102. The communication client application 112 performs the processing required at the user device 102 in order for the user device 102 to transmit and receive data over the communication system 100. The communication client application 112 executed at the user device 102 may be authenticated to communicate over the communication system through the presentation of digital certificates (e.g. to prove that user 104 is a genuine subscriber of the communication system—described in more detail in WO 2005/009019).

The second user device 108 and the third user device 116 may be the same or different to the user device 102.

The second user device 108 executes, on a local processor, a communication client application 114 which corresponds to the communication client application 112 executed at the user terminal 102. The communication client application 114 at the second user device 108 performs the processing required to allow User B 110 to communicate over the network 106 in the same way that the communication client application 112 at the user device 102 performs the processing required to allow the User A 104 to communicate over the network 106.

The third user device 116 executes, on a local processor, a communication client application 118 which corresponds to the communication client application 112 executed at the user terminal 102. The communication client application 118 at the third user device 116 performs the processing required to allow User C 110 to communicate over the network 106 in the same way that the communication client application 112 at the user device 102 performs the processing required to allow the User A 104 to communicate over the network 106.

The user devices 102, 108 and 116 are end points in the communication system.

FIG. 1 shows only three users (104, 110 and 120) and three user devices (102, 108 and 116) for clarity, but many more users and user devices may be included in the communication system 100, and may communicate over the communication system 100 using respective communication clients executed on the respective user devices, as is known in the art.

Furthermore FIG. 1 shows a synchronization device 130 allowing the users 104, 110, and 120 to asynchronously communicate with each other over the communication network 106.

The synchronization device 130 may be any suitable device. For example the synchronization device 130 may be a server, a distributed server system, or in some embodiments one of the user devices. The synchronization device 130 may be configured to receive, store and transmit asynchronous session data such as described herein. The asynchronous session data may for example be received from one of the user devices. The asynchronous session data may then at a later time be transmitted to one of the user devices to be reviewed. The asynchronous session data may then be modified by the user device being configured to generate, amend or delete annotation object data. The modified asynchronous session data can be stored on the synchronization device 130 and at a further later time be transmitted back to the generating user device or a further user device to allow the annotated objects to be presented in a suitable manner.

The synchronization device 130 may in some embodiments be configured to enable the synchronization in (near) real-time between user devices collaboratively editing the asynchronous session. For example the synchronous device 130 may be configured to receive annotation object edits (where annotation objects are generated, amended or deleted) from user devices. These received annotation object edits may then be noted or acknowledged and then passed to any further user device to be incorporated with collaborative asynchronous session.

Furthermore in some embodiments the synchronization device 130 may be configured to enable the merging of parallel or contemporaneous editing of asynchronous sessions. For example two user devices may be separately reviewing and editing the asynchronous session. The edits may be passed to the synchronization device 130, for example when the user devices close their review and edit session, and the synchronization device 130 may then merge the edits. For example the synchronization device 130 may determine whether there are any conflicting edits and where there are any conflicting edits determine which of the edits is dominant. The merged edited annotation object data may then be stored and transmitted to the next user device which requests the asynchronous session data.

The synchronization device 130 may for example execute a communication client application 134, provided by a software provider associated with the communication system 100. The communication client application 134 is a software program executed on a local processor in the synchronization device 130. The communication client application 134 performs the processing required at the synchronization device 130 in order for the synchronization device 130 to transmit and receive data over the communication system 100. The communication client application 134 executed at the synchronization device 130 may be authenticated to communicate over the communication system through the presentation of digital certificates.

The synchronization device 130 may be further configured to comprise a storage application 132. The storage application 132 may be configured to store any received asynchronous session data as described herein and enable the stored asynchronous session data to be retrieved by user devices when requested.

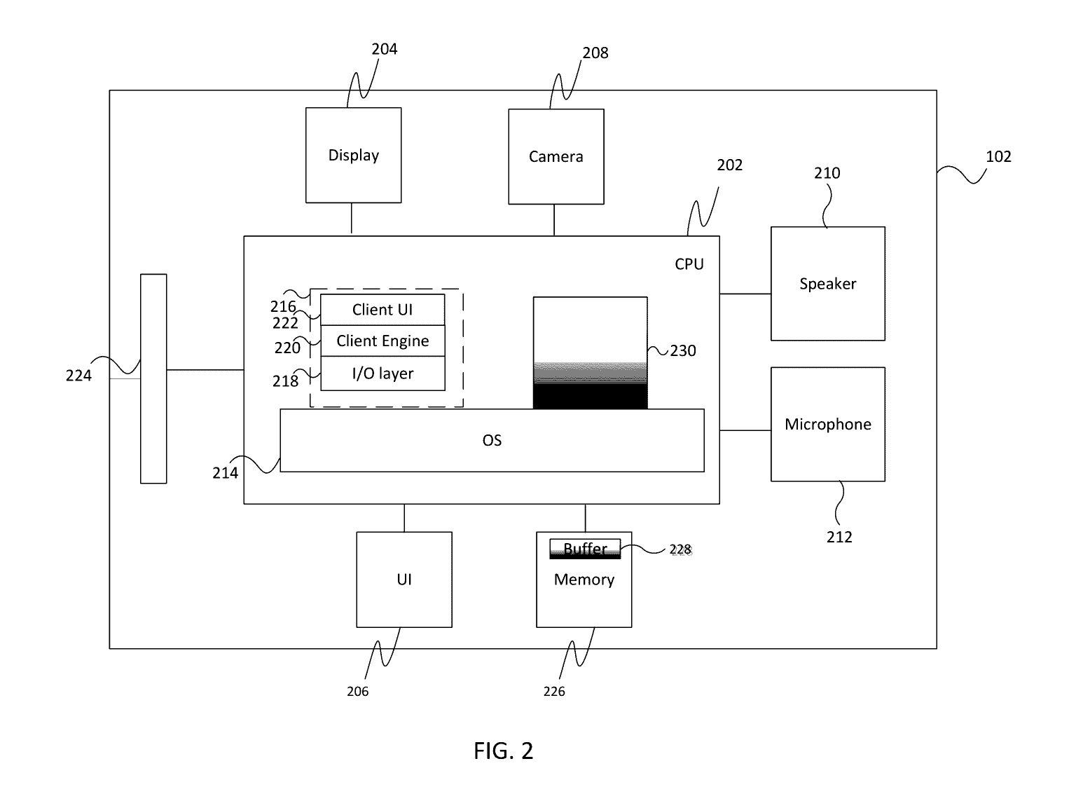

FIG. 2 illustrates a schematic view of the user device 102 on which is executed a communication client application for communicating over the communication system 100. The user device 102 comprises a central processing unit (“CPU”) 202, to which is connected a display 204 such as a screen or touch screen, input devices such as a user interface 206 (for example a keypad), a camera 208, and touch screen 204.

In some embodiments the user interface 206 may be a keypad, keyboard, mouse, pointing device, touchpad or similar. However the user interface 206 may be any suitable user interface input device, for example gesture or motion control user input, head-tracking or eye-tracking user input. Furthermore the user interface 206 in some embodiments may be a ‘touch’ or ‘proximity’ detecting input configured to determine the proximity of the user to a display 204.

In embodiments described below the camera 208 may be a conventional webcam that is integrated into the user device 102, or coupled to the user device via a wired or wireless connection. Alternatively, the camera 208 may be a depth-aware camera such as a time of flight or structured light camera. Furthermore the camera 208 may comprise multiple image capturing elements. The image capturing elements may be located at different positions or directed with differing points or view such that images from each of the image capturing elements may be processed or combined. For example the image capturing elements images may be compared in order to determine depth or object distance from the images based on the parallax errors. Furthermore in some examples the images may be combined to produce an image with a greater resolution or greater angle of view than would be possible from a single image capturing element image.

An output audio device 210 (e.g. a speaker, speakers, headphones, earpieces) and an input audio device 212 (e.g. a microphone, or microphones) are connected to the CPU 202. The display 204, user interface 206, camera 208, output audio device 210 and input audio device 212 may be integrated into the user device 102 as shown in FIG. 2. In alternative user devices one or more of the display 204, the user interface 206, the camera 208, the output audio device 210 and the input audio device 212 may not be integrated into the user device 102 and may be connected to the CPU 202 via respective interfaces. One example of such an interface is a USB interface.

The CPU 202 is connected to a network interface 224 such as a modem for communication with the communication network 106. The network interface 224 may be integrated into the user device 102 as shown in FIG. 2. In alternative user devices the network interface 224 is not integrated into the user device 102. The user device 102 also comprises a memory 226 for storing data as is known in the art. The memory 226 may be a permanent memory, such as ROM. The memory 226 may alternatively be a temporary memory, such as RAM.

The user device 102 is installed with the communication client application 112, in that the communication client application 112 is stored in the memory 226 and arranged for execution on the CPU 202. FIG. 2 also illustrates an operating system (“OS”) 214 executed on the CPU 202. Running on top of the OS 214 is a software stack 216 for the communication client application 112 referred to above. The software stack shows an I/O layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 214 manages the hardware resources of the computer and handles data being transmitted to and from the communication network 106 via the network interface 224. The I/O layer 218 comprises audio and/or video codecs which receive incoming encoded streams and decodes them for output to speaker 210 and/or display 204 as appropriate, and which receive unencoded audio and/or video data from the microphone 212 and/or camera 208 and encodes them for transmission as streams to other end-user devices of the communication system 100. The client engine layer 220 handles the connection management functions of the system as discussed above. This may comprise operations for establishing calls or other connections by server-based or peer to peer (P2P) address look-up and authentication. The client engine may also be responsible for other secondary functions not discussed herein. The client engine 220 also communicates with the client user interface layer 222. The client engine 220 may be arranged to control the client user interface layer 222 to present information to the user of the user device 102 via the user interface of the communication client application 112 which is displayed on the display 204 and to receive information from the user of the user device 102 via the user interface.

Also running on top of the OS 214 are further applications 230. Embodiments are described below with reference to the further applications 230 and communication client application 112 being separate applications, however the functionality of the further applications 230 described in more detail below can be incorporated into the communication client application 112.

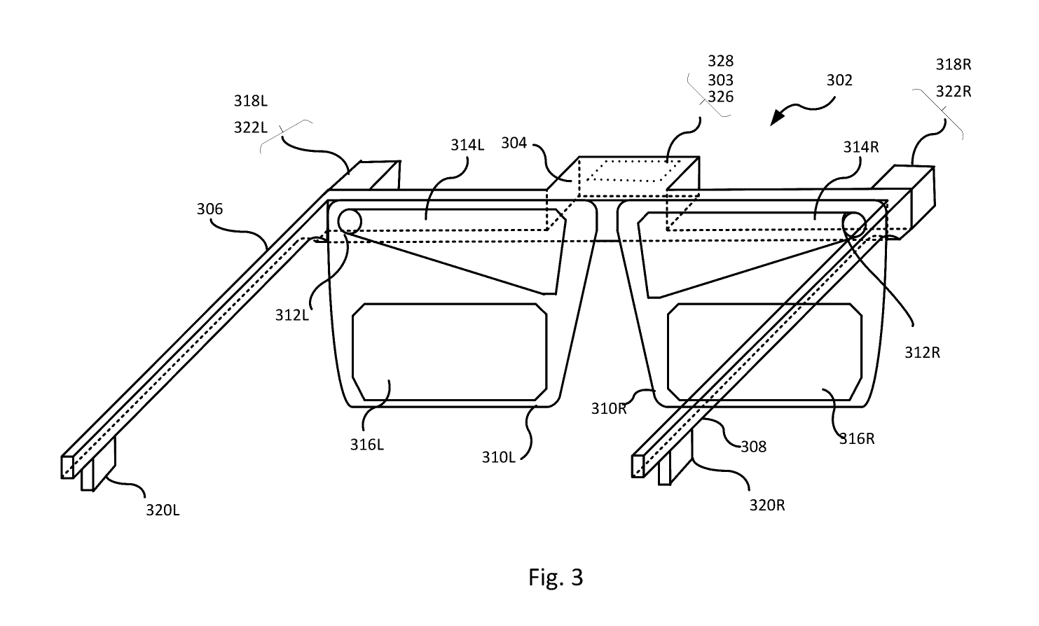

In one embodiment, shown in FIG. 3, the user device 102 is in the form of a headset or head mounted user device. The head mounted user device comprises a frame 302 having a central portion 304 intended to fit over the nose bridge of a wearer, and a left and right supporting extensions 306, 308 which are intended to fit over a user's ears. Although the supporting extensions 306, 308 are shown to be substantially straight, they could terminate with curved parts to more comfortably fit over the ears in the manner of conventional spectacles.

The frame 302 supports left and right optical components, labelled 310L and 310R, which may be waveguides e.g. formed of glass or polymer.

The central portion 304 may house the CPU 303, memory 328 and network interface 324 such as described in FIG. 2. Furthermore the frame 302 may house a light engines in the form of micro displays and imaging optics in the form of convex lenses and a collimating lenses. The light engine may in some embodiments comprise a further processor or employ the CPU 303 to generate an image for the micro displays. The micro displays can be any type of light of image source, such as liquid crystal display (LCD), backlit LCD, matrix arrays of LEDs (whether organic or inorganic) and any other suitable display. The displays may be driven by circuitry which activates individual pixels of the display to generate an image. The substantially collimated light from each display is output or coupled into each optical component, 310L, 310R by a respective in-coupling zone 312L, 312R provided on each component. In-coupled light may then be guided, through a mechanism that involves diffraction and TIR, laterally of the optical component in a respective intermediate (fold) zone 314L, 314R, and also downward into a respective exit zone 316L, 316R where it exits towards the users' eye.

The optical component 310 may be substantially transparent such that a user can not only view the image from the light engine, but also can view a real world view through the optical components.

The optical components may have a refractive index n which is such that total internal reflection takes place to guide the beam from the light engine along the intermediate expansion zone 314, and down towards the exit zone 316.

The user device 102 in the form of the headset or head mounted device may also comprise at least one camera configured to capture the field of view of the user wearing the headset. For example the headset shown in FIG. 3 comprises stereo cameras 318L and 318R configured to capture an approximate view (or field of view) from the user's left and right eyes respectfully. In some embodiments one camera may be configured to capture a suitable video image and a further camera or range sensing sensor configured to capture or determine the distance from the user to objects in the environment of the user.

Similarly the user device 102 in the form of the headset may comprise multiple microphones mounted on the frame 306 of the headset. The example shown in FIG. 3 shows a left microphone 322L and a right microphone 322R located at the ‘front’ ends of the supporting extensions or arms 306 and 308 respectively. The supporting extensions or arms 306 and 308 may furthermore comprise ‘left’ and ‘right’ channel speakers, earpiece or other audio output transducers. For example the headset shown in FIG. 3 comprises a pair of bone conduction audio transducers 320L and 320R functioning as left and right audio channel output speakers.

The concepts are described herein with respect to an asynchronous session for mixed reality (MR) applications, however in other embodiments the same concepts may be applied to any multiple party communication application. Asynchronous session mixed reality applications may for example involve the sharing of a scene which can be recorded at a first time and viewed and edited at a later time. For example a device comprising a camera may be configured to capture an image or video. The image or images may be passed to other devices by generating a suitable data format comprising the image data, surface reconstruction (3D mesh) data, audio data and annotation object data layers.

The asynchronous session data may, for example, be passed to the synchronization device 130 where it is stored and may be forwarded to the second and third user devices at a later time, such as after the user device 102 goes offline or is switched off.

The second and third user devices may be configured to augment or amend the image or video data within the asynchronous session data by the addition, amendment or deletion of annotation objects. These annotation objects (or virtual objects) can be ‘placed’ within the image scene and may have a visual representation which can be ‘seen’ and interacted with by the other participants (including the scene generator).

These annotation objects may be defined not only by position but comprise other attributes, such as object type, object author/editor, object date and object state. The annotation objects, for example, may have associated content such as audio/video/text content. A participant may, for example, place a video player object in a scene. This annotation object attributes may be further passed to the synchronization device 130 such that another participant may then view and interact with the object. For example another participant may interact with the video player object to start playing a video to watch. The same or other participant may then further interact with the video player object to control the playback or to change its position in the scene.

The placement of the annotation object may be made with respect to the scene and furthermore a three dimensional representation of the scene. In order to enable accurate placement of the annotation object to be represented or rendered on a remote device surface reconstruction (SR) or mesh data associated with the scene may be passed to the participants of the asynchronous session where the user device is not able to generate or determine surface reconstruction (SR) itself.

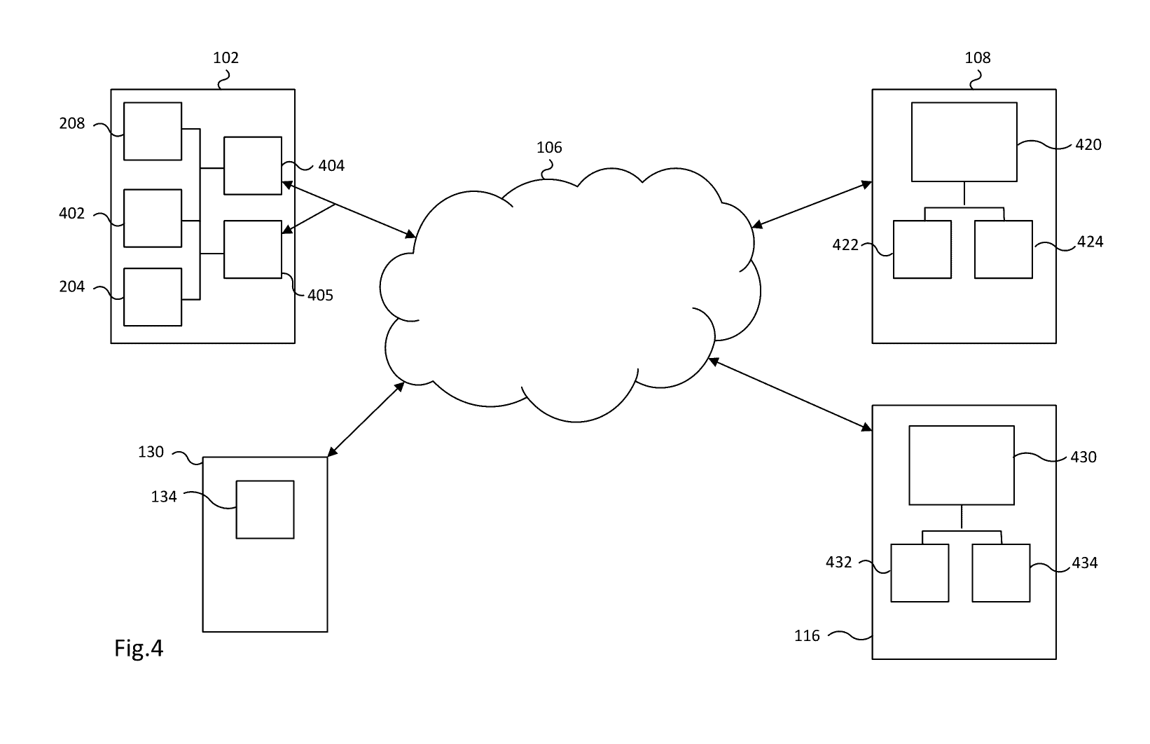

With respect to FIG. 4 a schematic of a suitable functional architecture for implementing an asynchronous communication session is shown. In the example shown in FIG. 4 the user device 102 is configured as the wearable scene generator or owner.

The user device 102 may therefore comprise a camera 208, for example a RGB (Red-Green-Blue) RGB sensor/camera. The RGB sensor/camera may be configured to pass the captured RGB raw data and furthermore pass any camera pose/projection matrix information to a suitable asynchronous session data generator 404.

Furthermore the user device 102 may comprise a depth sensor/camera 402 configured to capture depth information which can be passed to the asynchronous session data generator 404.

The asynchronous session data generator 404 may be configured to receive the depth information and generate surface reconstruction (SR) raw data according to a known mesh/SR method.

The asynchronous session data generator 404 may be configured to process the SR raw data and the RGB raw data and any camera pose/projection matrix information. For example the asynchronous session data generator 404 may be configured to encode the video raw data and the SR raw data (and camera pose/projection matrix data).

In some embodiments the asynchronous session data generator 404 may be configured to implement a suitable video encoding, such as H.264 channel encoding of the video data. It is understood that in some other embodiments the video codec employed is any suitable codec. For example the encoder and decoder may employ a High Efficiency Video Coding HEVC implementation.

The encoding of the video data may furthermore comprise the camera pose or projection matrix information. Thus the asynchronous session data generator 404 may be configured to receive the raw image/video frames and camera pose/projection matrix data and process these to generate an encoded frame and SEI (supplemental enhancement information) message data comprising the camera pose information.

The camera intrinsic (integral to the camera itself) and extrinsic (part of the 3D environment the camera is located in) data or information, such as camera pose (extrinsic) and projection matrix (intrinsic) data, describe the camera capture properties. This information such as frame timestamp and frame orientation should be synchronized with video frames as it may change from frame to frame.

The asynchronous session data generator 404 may be configured to encode captured audio data using any suitable audio codec.

The asynchronous session data generator 404 may furthermore be configured to encode the SR raw data to generate suitable encoded SR data. The SR data may furthermore may be associated with camera pose or projection matrix data.

Furthermore the asynchronous session data generator 404 may furthermore initialise a link to (or enable the storage of) at least one annotation object. Thus in some embodiments the annotation objects may be encoded in a manner that enables the annotation objects to be linked to or associated with SR data in order to ‘tie’ the annotation to an SR object within the scene.

The architecture should carry the data in a platform agnostic way. The application program interface (API) call sequences, for example, are described for the sender pipeline.

For example the RGB camera may be configured to generate the RGB frame data. The RGB frame data can then be passed to the OS/Platform layer and to a media capture (and source reader) entity. The media capture entity may furthermore be configured to receive the camera pose and projection matrix and attach these camera intrinsic and extrinsic values as custom attributes. The media sample and custom attributes may then be passed to a video encoder. The video encoder may, for example, be the H.264 channel encoder. The video encoder may then embed the camera pose and projection matrix in-band and annotation object layer as a user data unregistered SEI message.

The SEI message may for example be combined in a SEI append entity with the video frame data output from a H.264 encoder. An example SEI message is defined below:

| | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|
| | | | | | | | | | 1 | | | | | | | | | | 2 | | | | | | | | | | 3 | |
| | | | | | | | | | 1 | | | | | | | | | | 2 | | | | | | | | | | 3 | |
| 0 | 1 2 | 3 | 4 | 5 | 6 | 7 | 8 | 9 | 0 | 1 | 2 | 3 | 4 | 5 | 6 | 7 | 8 | 9 | 0 | 1 | 2 | 3 | 4 | 5 | 6 | 7 | 8 | 9 | 0 | 1 |

| | | | | | |
|---|---|---|---|---|---|
| F | NRI | Type | payloadType | payloadSize | uuid_iso_iec_11578 |

| | | | |
|---|---|---|---|
| uuid_iso_iec_11578 | | | |
| uuid_iso_iec_11578 | | | |
| uuid_iso_iec_11578 | | | |
| uuid_iso_iec_11578 | T | L | V |
| More TLV tuples . . . | | | |

where

F (1 bit) is a forbidden_zero_bit, such as specified in [RFC6184], section 1.3,

NRI (2 bits) is a nal_ref_idc, such as specified in [RFC6184], section 1.3,

Type (5 bits) is a nal_unit_type, such as specified in [RFC6184], section 1.3. which in some embodiments is set to 6,

payloadType (1 byte) is a SEI payload type and in some embodiments is set to 5 to indicate a User Data Unregistered SEI message. The syntax used by this protocol is as defined in [ISO/IEC14496-10:2010], section 7.3.2.3.1,

payloadSize (1 byte) is a SEI payload size. The syntax that is used by this protocol for this field is the same as defined in [ISO/IEC14496-10:2010], section 7.3.2.3.1. The payloadSize value is the size of the stream layout SEI message excluding the F, NRI, Type, payloadType, and payloadSize fields,

uuid_iso_jec_11578 (16 bytes) is a universally unique identifier (UUID) to indicate the SEI message is the stream layout and in some embodiments is set to {OF 5DD509-CF 7E-4AC4-9E9A-406B68973 C42},

T (1 byte) is the type byte and in some embodiments a value of 1 is used to identify camera pose info and a value of 2 is used to identify camera projection matrix info,

L (1 byte) is the length in bytes of the subsequent value field minus 1 and has a valid value range of 0-254 indicating 1-255 bytes,

V (N byte) is the value and the length of the value is specified as the value of the L field.

The asynchronous session data generator 404 outputs the video, SR, audio and annotation object data via a suitable output to the synchronization device 130 where the data may be stored and recalled at a later time by a further user device (or the same user device).

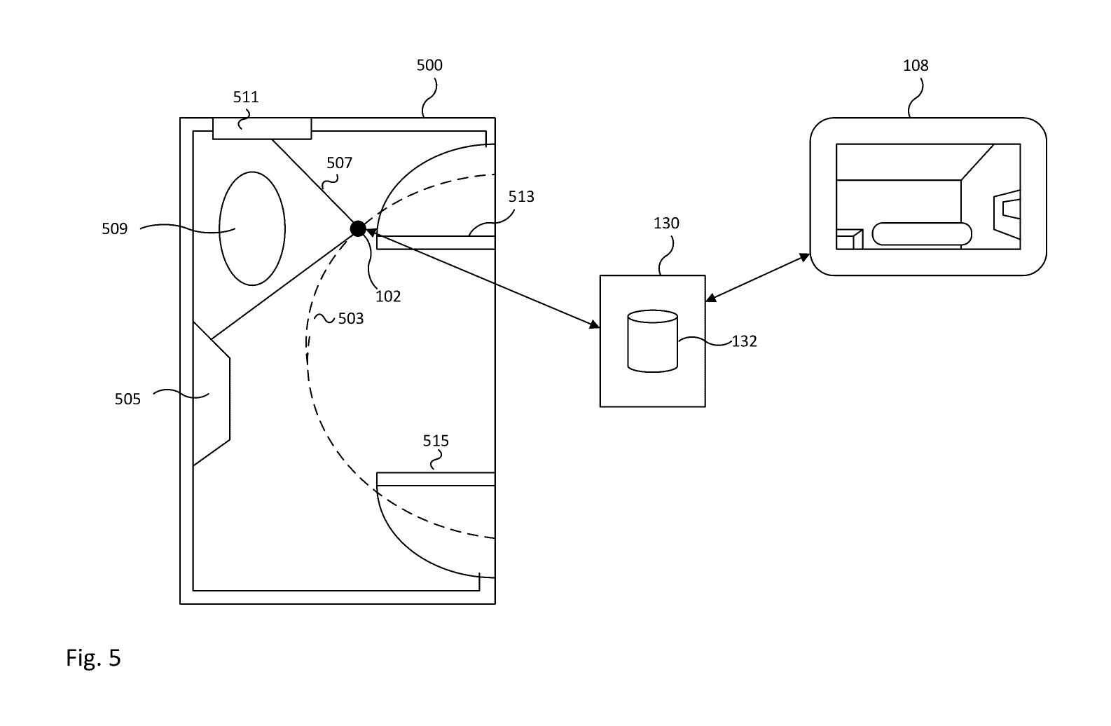

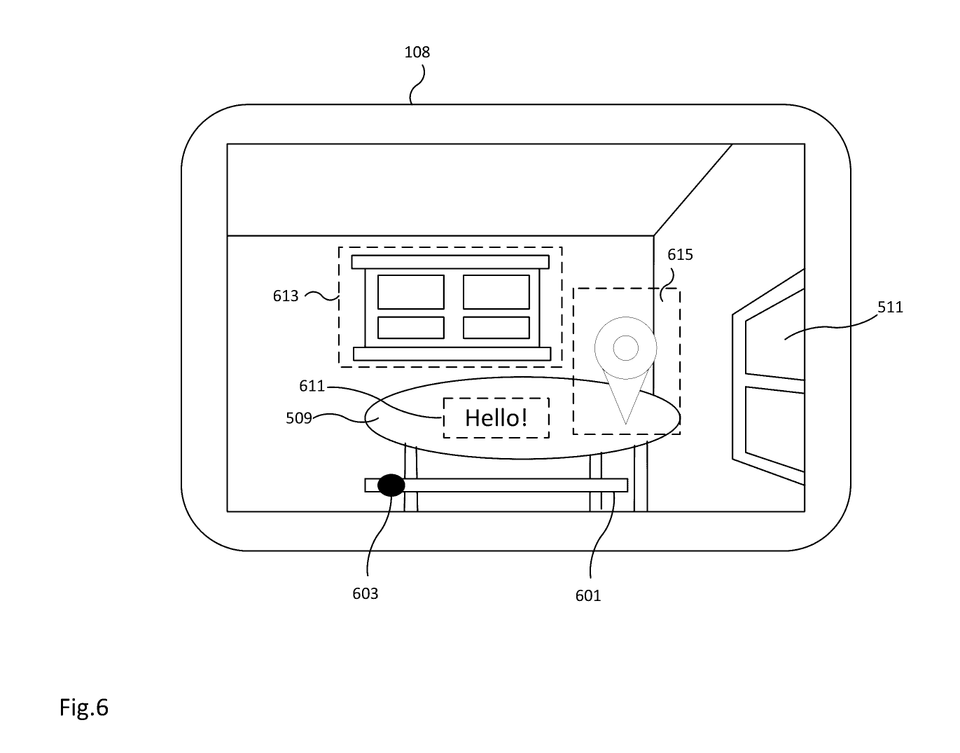

An example asynchronous session generation implementation and asynchronous session review implementation is shown in FIGS. 5 and 6. The user device 102 records the scene of a room 500 comprising doors 513, 515 a table 509 and cabinet 505. The user device 102 operated by user A may for example start recording the scene when entering the room 500 through a first door 513 and follow a path 503 until leaving the room 500 via a second door 515. At a certain instance as shown in FIG. 5 the user device camera view 507 is one of the table 509, window 511 and wall behind the table 509.

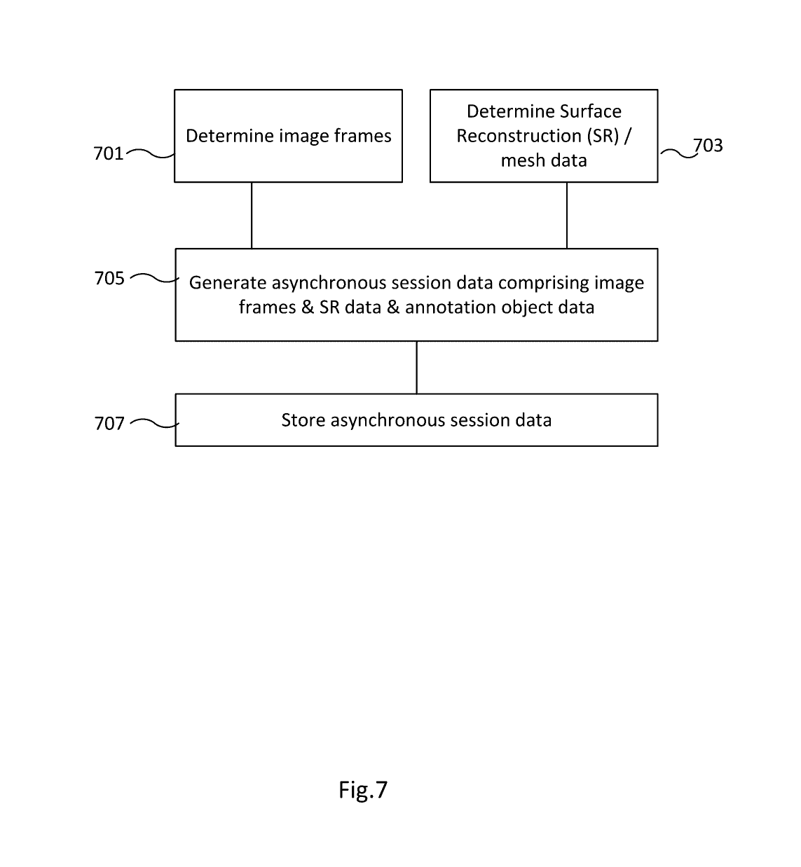

With respect to FIG. 7 a flow diagram of the method of generating the asynchronous session data is shown with respect to some embodiments.

In such an example the camera image frames are captured and encoded.

The operation of determining the image frames is shown in FIG. 7 by step 701.

Furthermore the surface reconstruction (SR) or mesh or 3D model information is also determined.

The operation of determining the SR or mesh data is shown in FIG. 7 by step 703.

The image and mesh data may then be combined to generate the asynchronous session data. The asynchronous session data may furthermore comprise audio data and furthermore annotation object data. In some embodiments the annotation object data comprises a null field or placeholder indicating where the annotation object data may be stored when an annotation is created or furthermore an identifier for the data channel over which the annotation object data may be transmitted and/or synchronised between users as described herein.

The operation of generating the asynchronous session data comprising the image data, SR (mesh) data and annotation object data is shown in FIG. 7 by step 705.

The asynchronous session data may then be stored, for example within the synchronization device 130.

The operation of storing the asynchronous session data comprising the image data, SR (mesh) data and annotation object data is shown in FIG. 7 by step 707.

The synchronization device 130 may thus be configured to receive the asynchronous session data object and store the asynchronous session data.

Furthermore in some embodiments the synchronization device 130 may comprise a synchronization application 134 configured to maintain the asynchronous session data. The maintenance of the session data and specifically the annotation object data may be performed in such a manner that when more than one user is concurrently viewing or editing the asynchronous session data that the scene experienced is consistent.

This may for example be expressed as the synchronization application 134 being configured to enable a synchronization of session data between a collaboration of user devices.

For example in some embodiments the synchronization device 130 may be configured to receive from the user devices 102, 108 and 116 information identifying any new or added, amended or deleted annotation objects associated with the asynchronous session. Furthermore the synchronization application 134 may determine whether the user device 102, 108, 116 attempting the make a change to the annotation object has the associated permissions to make the change and synchronize the change within the asynchronous session data.

With respect to the example shown in FIG. 4 the second user device 108 and the third user device 116 are shown viewing and editing the data object.

In a first example the second user device 108 is configured to retrieve from the synchronization device 130 the stored asynchronous session data. The second user device 108 comprises an asynchronous session viewer or editor 422 configured to retrieve, parse and decode the asynchronous session data such that the video components may be passed to a suitable display 420. Furthermore the asynchronous session viewer or editor 422 may be configured to parse the asynchronous session data to extract and display any annotation objects currently associated with the video image being displayed in a suitable form. Although the examples presented herein show a video image being displayed it is understood that in some embodiments the annotation object may comprise an audio component and although being located with respect to the image and SR data may be presented to the user via an audio output, for example by spatial audio signal processing an annotation object audio signal.

The encoded SR data may, for example, be passed to a SR channel decoder to generate SR raw data.

The encoded H.264 video data may furthermore be decoded to output suitable raw frames and camera pose/projection matrix data. The SR raw data and the raw frames and camera pose/projection information can then be passed to a video sink.

The video sink may then be configured to output the received SR raw data and the raw frames and camera pose/projection data to any suitable remote video applications or libraries for suitable 3D scene rendering (at a 3D scene renderer) and video service rendering (at a video surface renderer).

A video decoder may be implemented as a H.264 channel decoder which may comprise a SEI extractor configured to detect and extract from the H.264 frame data any received SEI data associated with the camera intrinsic and extrinsic data values (the camera pose and/or projection matrix data). This may be implemented within the video decoder by the decoder scanning and extracting camera intrinsic and extrinsic data and annotation object data (if present) from the SEI message appended with each frame. The data may then be made available to the decoder extension and the decoder callback via decoder options.

The video decoder, for example the H.264 decoder, may then decode the encoded H.264 data not containing the SEI message.

The decoder may further comprise a renderer configured to synchronise the intrinsic and extrinsic data, the annotation object data and the frame data and pass it to the OS/platform layer.

The OS/platform layer may furthermore comprise a 3D render engine configured to convert the video frame image and with the intrinsic and extrinsic data, annotation object data and the SR data to generate a suitable 3D rendering suitable for passing to a display or screen. It is understood that the 3D render engine may be implemented as an application in some embodiments.

As described herein one of the aspects of asynchronous session scene review or edit is the ability to annotate a captured scene. For example the video captured by one participant in the scene may be annotated by the addition of an annotation object. The annotation object may be located in the scene with a defined location and/orientation. Furthermore the annotation object as described herein may be associated with a media type—such as video, image, audio or text. The annotation object may in some situations be an interactive object in that the annotation object may be movable, or changed.

For example the annotation object may be associated with a video file and when the object is ‘touched’ or selected by a participant the video is played to the participant viewing the scene.

The adding, removing and modifying objects within a scene may be problematic. However these problems may be handled according to the example architectures and protocols for object information described in further detail herein.

The asynchronous session editor or viewer 422 may thus in some embodiments further comprise an asynchronous session navigator. The asynchronous session navigator may be configured to ‘navigate’ the retrieved asynchronous session data in order to enable the user to view (and edit) the asynchronous session.

In such embodiments the second user device 108 comprises a suitable user interface input 424, for example a keypad, or touchscreen input from which a position within the stored scene within the asynchronous session data may be accessed.

The example in FIG. 5 shows where the second user device 108 receives and displays the asynchronous session data. This for example is shown in the example user interface display shown in FIG. 6. In the example shown in FIG. 6 the asynchronous session navigator user interface is provided by a scrubber or slider 601 on which the user may select by moving an index 603 over the length of the scrubber 601 to navigate along the path of the recording in order to view and identify an SR object on which user B wishes to attach, amend or remove or interact with an annotation object.

Although the example shown in FIG. 6 shows a scrubber or slider which provides a positional navigation of the captured scene asynchronous session as the captured scene camera view changes over time it is understood that the asynchronous session navigator may navigate the scene according to any suitable method. For example in some embodiments the captured asynchronous session scene data is initially analysed and the range of camera positions determined enabling the object navigator to search by view locations directly.

Thus in FIG. 6 the index is moved along the scrubber or slider such that the image presented to the user is that shown in FIG. 5.

Furthermore the asynchronous session editor or viewer 422, in some embodiments, may permit the user device to edit the asynchronous session data by adding, amending or deleting annotation objects within the asynchronous session data. In some embodiments the asynchronous session editor or viewer 422 may permit the editing of the asynchronous session data where the user device has a suitable permission level.

In other words the asynchronous session editor or viewer 422 may permit the user to edit the stored scene by adding, removing or editing annotations to the recorded images (and SR data).

The asynchronous session editor or viewer 422 in some embodiments may pass or transmit the edited annotation object information to the synchronization device 130 which determines whether the user device has the required permission level and includes any edits made by the user device asynchronous session editor or viewer 422 such that the edits may be viewed by any other user device.

Thus in FIG. 6 the user B is able to add annotation objects such as a first annotation object 611, a text object, to the table 509, a second annotation object 615, a video object, also to the table 509 and a third annotation object 613, an image object of a window, to the wall behind the table 509. These annotations may be added as an annotation object layer to the asynchronous session data and these edits passed back to the synchronization device 130 to be stored.

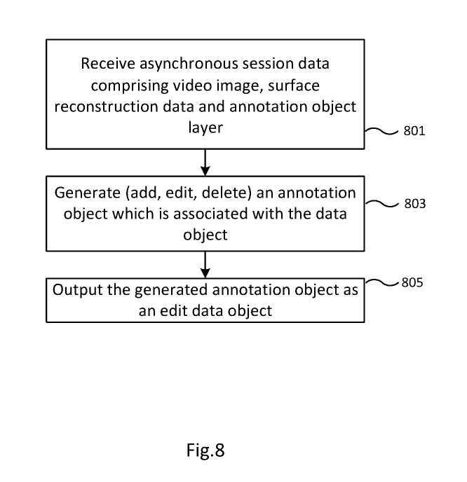

A summary of the process of editing a data object according to some embodiments within a user device is shown in FIG. 8.

The user device 108 in some embodiments receives the asynchronous session data comprising the video data, the SR (or mesh) data and furthermore the annotation object (or edit layer) data.

The operation of receiving the asynchronous session data, for example from the synchronization device 130, is shown in FIG. 8 by step 801.

Furthermore the user device may be configured to generate an annotation object which is associated with the asynchronous session data (and the surface reconstruction data) and with respect to a camera position of the capture event.

The operation of generating an annotation object is shown in FIG. 8 by step 803.

The user device may furthermore be configured to output the generated annotation object data as an edit data object.

The operation of outputting the annotation object as an edit data object is shown in FIG. 8 by step 805.

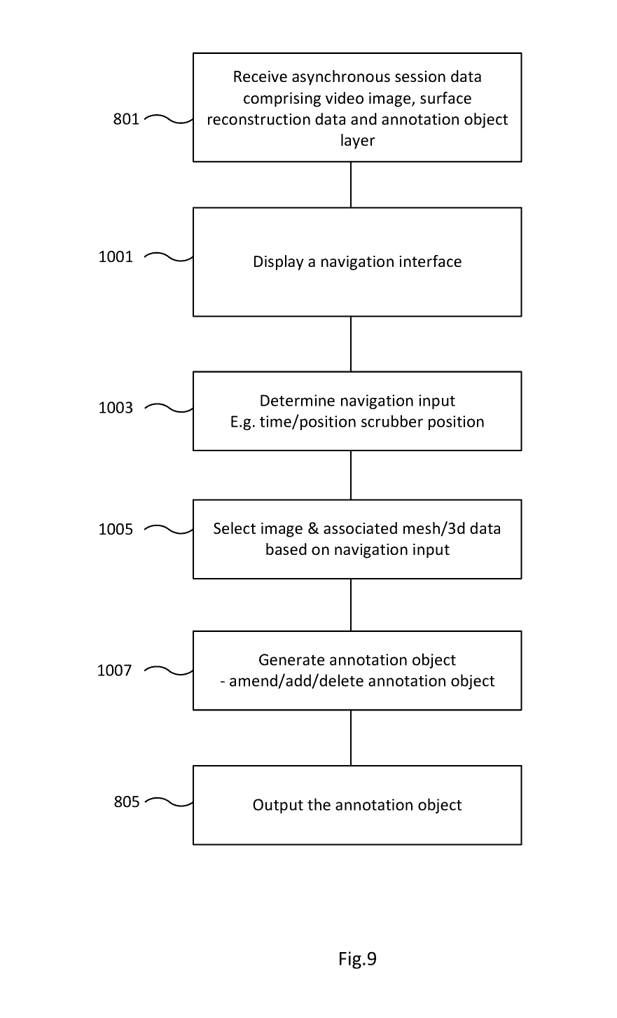

FIG. 9 furthermore shows a flow chart of the processes of navigating the asynchronous session data within an asynchronous session reviewing process to generate, amend or delete an annotation object such as shown in FIG. 8.

Thus the initial step of receiving the asynchronous session data is followed by the user device generating a visual output based on the rendered video and the user interface input enabling a navigation through the captured scene.

As described herein the navigation can in some embodiments be one of navigating to a position by use of a time index on a time scrubber such that the selection follows the path followed by the capture device. In some embodiments the navigation operation is implemented by a positional scrubber or other user interface enabling the location and the orientation of the viewer being determined directly. For example in some embodiments the scene is navigated by generating a positional choice from a user interface which may be mapped to the asynchronous session data. For example the mapping may follow a positional indexing operation wherein the camera pose data is used to generate an index of available camera positions from which the viewpoint may be selected.

The operation of displaying a navigation interface is shown in FIG. 9 by step 1001.

The operation of determining a navigation input based on the navigation interface is shown in FIG. 9 by step 1003.

The user device thus then may select from the asynchronous session data the image and associated SR (or mesh) data based on the navigation input. In some embodiments the user device may further determine whether there are any current annotation objects within the camera viewpoint or as described herein later any current annotation objects and generate suitable image overlays to be displayed.

The operation of selecting an image to be displayed and associated SR (or mesh) data based on the navigation input is shown in FIG. 9 by step 1005.

The user may then generate select a portion of the image to generate an annotation object amendment, addition or deletion. The annotation object may be added, amended, interacted with or deleted. Thus would therefore comprise the generation of an annotation object with attributes such as ‘anchored location’, creation/edit date, state of object etc. It is understood that the generation of an object includes the actions of generating a ‘deletion’ annotation object, or ‘amendment’ annotation object.

The operation of generating an annotation object by editing the image is shown in FIG. 9 by step 1007.

The annotation object may then be output, for example the annotation object may be output to the synchronization device 130.

The operation of outputting the annotation object is shown in FIG. 9 by step 805.

The visualisation, location and interaction with such objects in a captured scene as described previously may present problems. For example in a further example the third user device 116 may be further configured to retrieve from the synchronization device 130 the stored asynchronous session data. The third user device 116 may comprise an asynchronous session editor or viewer 432 configured to retrieve, parse and decode the asynchronous session data such that the video components may be passed to a suitable display 430. Furthermore the asynchronous session editor or viewer 432 may be configured to parse the asynchronous session data to extract and display any annotation objects currently associated with the video image being displayed in a suitable form. In some embodiments the second and the third user devices may be running non-concurrent sessions (in other words one of the devices finishes viewing and editing the captured asynchronous session scene before the other device starts viewing and editing the same scene). In such embodiments the synchronization device may be configured to store the annotation objects such that the later viewer is able to retrieve the annotation objects generated (added, amended or deleted) by the earlier viewer.

Furthermore in some embodiments the second and third user devices may be separately reviewing and editing the asynchronous session but doing so contemporaneously. In such embodiments the synchronization device 130 may be configured to enable the merging of parallel or contemporaneous editing of asynchronous sessions. The edits may be passed to the synchronization device 130 and the synchronization device 130 may then merge the edits. For example the synchronization device 130 may determine whether there are any conflicting edits and where there are any conflicting edits determine which edit is dominant. The merged edited annotation object data may then be stored and transmitted to the next user device which requests the asynchronous session data.

In some embodiments the user devices may be running a concurrent session (in other words both devices may be capable of editing the asynchronous session scene at the same time). The synchronization device 130 may in such embodiments be configured to enable the synchronization in (near) real-time between user devices. For example the synchronous device 130 may be configured to receive annotation object edits (where annotation objects are generated, amended or deleted) from user devices. These received annotation object edits may then be noted or acknowledged and then passed to any further user device to be incorporated with collaborative asynchronous session.

An annotation object may have a visual representation and have associated content (such as audio/video/text). A participant may, for example, place a video player object in a captured scene, and enable other participants to interact with it to start playing a video. Another participant may attempt to interact with the same annotation object to control the playback or to change the position of the object in the scene. As such the annotation object should appear at the same position relative to the real-world objects within the video or image and other (virtual) objects for all of the participants participating in the collaborative asynchronous session.

Furthermore the state of the annotation object should also be consistent, subject to an acceptable delay, for all of the participants participating in the collaborative asynchronous session. Thus for example the video object when playing a video should display the same video at approximately the same position.

The captured asynchronous session scene or mixed reality application should also be implemented such that a participant joining a collaboration session at any time is able to synchronise their view of the asynchronous session scene with the views of the other participants. In other words the asynchronous session scene is the same for all of the participants independent of when the participant joined the session.

The architecture described herein may be used to implement a message protocol and set of communication mechanisms designed to efficiently meet the requirements described above. The concept can therefore involve communication mechanisms such as ‘only latest reliable message delivery’ and ‘object-based’ flow control. The implementation of ‘only latest message delivery’ may reduce the volume of transmitted and/or received object information traffic and therefore utilise processor and network bandwidth efficiently. This is an important and desirable achievement for mobile and wearable devices where minimising processor utilisation and network bandwidth is a common design goal. Similarly object-based flow control allows a transmitter and receiver to selectively limit traffic requirements for synchronising the state of a given object.

In some embodiments, the synchronization device 130 may be configured to relay messages in the form of edited annotation object data between user devices such that user devices which are concurrently viewing or editing the captured scene can view the same scene.

The user devices may thus employ an application (or app) operating as a protocol client entity. The protocol client entity may be configured to control a protocol end point for communicating and controlling data flow between the protocol end points.

In the following examples the annotation object message exchange is performed using the synchronization device 130. In other words annotation object messages pass via the synchronization device 130 which forwards each message to its destination.

It is understood that in some embodiments the message exchange is performed on a peer to peer basis. As the peer to peer message exchange case is conceptually a special case of the server mediated case where the scene owner endpoint and server endpoint are co-located on the same device then the following examples may also be applied to peer to peer embodiments.

The data model herein may be used to facilitate the description of the protocol used to synchronise the objects (and therefore annotations) described herein. At each protocol endpoint (such as the synchronization device and user device(s)) a session management entity or session management entity application may maintain a view of the shared scene. The view of the captured asynchronous session scene may be a representation of the objects (or annotations) within the asynchronous session scene. The annotation object representation may comprise annotation data objects comprising attributes such as object type, co-ordinates, and orientation in the space or scene. The protocol endpoints may then use the session management entity application to maintain a consistent scene view using the object representations. In such a manner any updates to the representation of an asynchronous session scene object can be versioned and communicated to other endpoints using protocol messages. The synchronization device 130 may relay all of these annotation object messages and discard updates based on stale versions where applicable.

In some embodiments the protocol for exchanging annotation object messages can be divided into a data plane and a control plane. At each protocol endpoint the data plane may implement an annotation object message delivery entity application and a packet delivery entity application which are responsible for maintaining annotation object message queues/packet queues and keeping track of the delivery status of queued transmit and/or receive annotation object messages and packets. In the following embodiments an outstanding outbound annotation object message is one that has been transmitted but not yet acknowledged by the receiver. An outstanding inbound annotation object message is an annotation object message that has been received but has not been delivered to the local endpoint (for example the session management entity).

The control plane can be implemented within the synchronization device 130 endpoint and may be configured to maintain the state of the scene between the participants currently viewing the asynchronous session scene. For example the synchronization device 130 may be configured to maintain the protocol version and endpoint capabilities for each connected endpoint.

In the following examples the synchronization device 130 may be configured to create an endpoint using the protocol client entity and obtain the address of the server endpoint. The address determination may be through a static configuration address or through domain name system (DNS) query.

The protocol client entity application may then assert itself as a scene owner.

The participant endpoint may then use its protocol client application following receiving the data object to register interest in maintaining scene synchronization.

The synchronization device 130 may then determine whether or not the participant is authorised to participate and generate a synchronization response message. The synchronization response message may then be transmitted to the user device.

The synchronization device 130 and the user devices may maintain suitable timers. For example a keepalive timers may be employed in some embodiments to trigger the sending of keepalive messages. Similarly retransmission timers may be implemented to trigger retransmission only for reliable messages.

In some embodiments the architecture comprises a logic layer, which can comprise any suitable application handling object information.

The logic layer may be configured to communicate with an I/O or client layer via a (outbound) send path and (inbound) receive path.

The I/O or client layer may comprise a resource manager. The resource manager may control the handling of object data. Furthermore the resource manager may be configured to control an (outbound message) sending queue and (inbound message) receiving queue.

Furthermore the resource manager may be configured to transmit control signals to the OS layer 505 and the NIC driver. These control signals may for example be CancelSend and/or SetReceiveRateLimit signals which may be sent via control pathways to the OS layer and NIC driver.

The send queue may be configured to receive packets from the resource manager and send the packets to the OS layer by the sent pathway. The receive queue may be configured to receive messages from the OS layer via the receive pathway.

The OS layer may receive outbound messages from the send queue and pass these via a send path to the NIC driver. Furthermore the OS layer can receive messages from the NIC driver by a receive path and further pass these to the receive queue via a receive pathway.

The synchronization device 130 implementing a session management entity may be configured to maintain or receive the annotation object representation attributes and furthermore detect when any annotation object interaction instructions are received. For example a user may move or interact with an annotation object causing one of the attributes of the annotation object to change. The session management entity may be configured to process the annotation object interaction instructions/inputs and generate or output modified annotation object attributes to be passed to the message delivery entity/packet delivery entity. Furthermore the connection state entity application may be configured to control the message delivery entity/packet delivery entity.

Thus, for example, the synchronization device 130 implementing a session management entity may generate a new or modified annotation object attribute message.

The annotation object attribute message may be passed to a message delivery entity and the message is stamped or associated with a sequence number and object identify value. The object identify value may identify the object and the sequence number identify the position within a sequence of modifications.

The message delivery entity may then be configured to determine whether a determined transmission period has ended.

When the period has not ended then the method can pass back to the operation of generating the next modified object attribute message.

However when a period has be determined then the message delivery entity may be configured to check for the period all of the messages with a determined object identifier value.

The message delivery entity may then be configured to determine the latest number of messages (or a latest message) from the messages within the period based on the sequence number.

The message delivery entity may then be configured to delete in the send path all of the other messages with the object identify value for that specific period.

The method can then pass back to checking for further object interaction instructions or inputs.

In implementing such embodiments the message flow of annotation object attribute messages for a specific object for a given period can be controlled such that there is a transmission of at least one message updating the state or position of a given object but the network is not flooded with messages. Furthermore the Send Path API may be made available at all layers for the application to discard excess messages queued with the send path for a given object ID.

Furthermore in some embodiments the sender may be configured to provide feedback about attempted or cancelled transmissions.

The synchronization device 130 in implementing such embodiments as described above may be configured to provide or perform application layer multicasting without exceeding the receivers' message rate limits.

Similarly the receive path implementation of annotation object synchronization may refer to all incoming queue stages with the application's transport layer entities at the endpoints, the underlying operating system and the network driver.

In some embodiments annotation object attribute messages such as described with respect to the send path are received.

A message delivery entity may furthermore be configured to determine whether or not a determined period has ended.

When the period has not ended then the method may loop back to receive further annotation object attribute messages.

When the period has ended then a connection state entity application may then be configured to determine some parameter estimation and decision variables on which the control of receive messages may be made.

For example in some embodiments a connection state entity application may be configured to determine the number of CPU cycles required or consumed per update process.

In some embodiments a connection state entity application may be configured to determine or estimate a current CPU load and/or the network bandwidth.

Furthermore in some embodiments a connection state entity application may be configured to determine an annotation object priority for a specific annotation object. An annotation object priority can be, for example, based on whether the annotation object is in view, whether the object has been recently viewed, or the annotation object has been recently interacted with.

The connection state entity application may then in some embodiments be configured to set a ‘rate limit’ for annotation object updates based on at least one of the determined variables and the capacity determination.

The message delivery entity may then be configured to determine the last ‘n’ messages for the object within the period, where ‘n’ is the rate limit. This may for example be performed by determining the last ‘n’ sequence numbers on the received messages for the object ID over the period.

The application can then delete in the received path all of the messages for that object ID for that period other than the last ‘n’ messages.

The method may then pass back to the operation of receiving further object messages.

In such a manner the receiver is not overloaded with annotation object attribute messages.

Furthermore the synchronization device 130 thus maintains a current and up-to-date list of the annotation object data such that when no users are viewing or editing the asynchronous session the annotation object data is not lost.

Thus for example at a still later time the first user device 102 may be configured to retrieve from the synchronization device 130 the edited asynchronous session data. The first user device 102 may for example comprise an asynchronous session viewer 405 configured to retrieve, parse and decode the asynchronous session data such that the representations of the annotation objects may be passed to a suitable display 204 without the need to decode or display the video data.

In such embodiments the asynchronous session viewer or editor 405 may be considered to be a modified version of the asynchronous session viewer or editor as shown in the second user device and the third user device.

In order that the asynchronous session is able to be viewed or edited on the wearable device such as shown by user device 102 or another wearable user device, the user device may be configured to recognize the scene. In other words the user device may be configured to recognize that the room is the same room from the generated asynchronous session. Then the user device may be configured to receive and render the annotation objects that have been stored with that scene.

In some embodiments the user device may be configured to only receive the annotation object data. In such embodiments the video, camera pose and SR data is optionally received. In other words there is no synchronization of camera pose or mesh data, because the wearable user device may be able to generate updated versions of both.

For example: user A may take the user device 102 and scan his bedroom. User B takes the bedroom scan and writes with a tablet “Happy Birthday” on one wall to generate an annotation object which is stored for later recall. User A at some later time switches the user device 102 back on and goes into the bedroom and sees “Happy Birthday” on the wall. In such an example in order to display the message it is not necessary for the later viewing to have the knowledge of the FOV User A had while scanning the room. Whether the user stood in one position then, is immaterial to seeing the annotation since the user is looking around under his own power.

It is not necessary to have prior mesh data to determine the position for displaying a generated an image overlay. For example if user A moved a chair in the bedroom, between capturing the scene and viewing the scene with the annotation when putting the user device on again, he might now not understand why when he adds an annotation object text “Thanks!” it is getting warped around a chair that is physically not there anymore. So, it only makes sense to use the updated mesh from the latest session.

In summary the knowledge of the camera view based on camera pose isn't required to display or edit annotations in the room.

In some embodiments the asynchronous session viewer or editor 405 may be configured to enable the user A of the user device 102 to generate amended or new annotation objects.

The asynchronous session viewer 405 (or the asynchronous session editor) in some embodiments may be configured to determine a difference between the current position of the device (or the currently navigated or viewed camera position) and an annotation object position in order to generate a suitable overlay to represent the annotation object and output the image overlay. The image overlay may thus be generated based on the current camera/user position and the annotation object position.

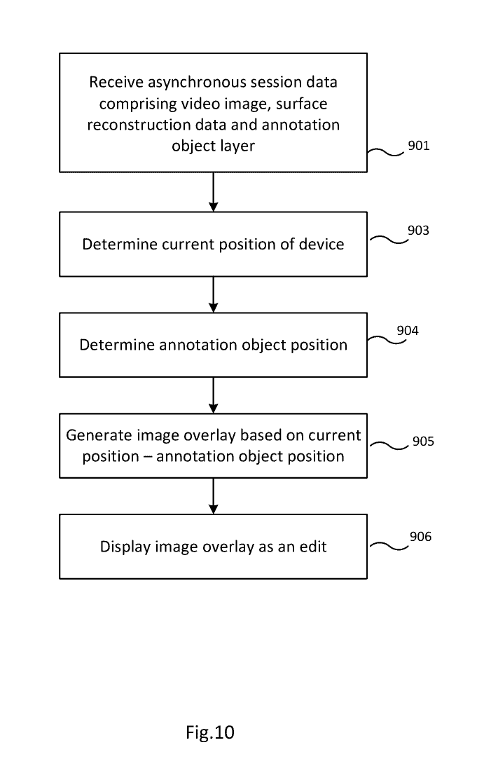

FIG. 10 for example shows a flow diagram of a process of reviewing the asynchronous session data to present an annotation object.

The user device, for example the user device 102, may thus receive the asynchronous session data comprising the annotation object data. As described herein, in some embodiments, the annotation object data may be received separately from the other data components. For example the data may be received as a file or may be received as a data stream or a combination of file and stream data.

The operation of receiving the asynchronous session data is shown in FIG. 10 by step 901.

The user device may then be configured to determine the current position of the device. The current position of the device, for a wearable device, may be the physical position of the device in the scene. The current position of the device, in some embodiments, may be the navigation position of the device in the scene.

The operation of determining a current position of the device is shown in FIG. 10 by step 903.

The user device may furthermore be configured to determine the position of at least one of the annotation objects. The position of the annotation object may be determined directly from the annotation object data or may be determined by referencing the annotation object data with respect to at least one of the SR data and/or the video data.

The operation of determining a position of at least one of the annotation objects is shown in FIG. 10 by step 904.

The user device may furthermore in some embodiments be configured to determine an image overlay based on the current position of the user device and the annotation object. The image overlay may for example be an image to be projected to the user via the wearable device output such that the overlay is shown ‘over’ the real world image seen by the user as a form of augmented reality view. In some embodiments the image overlay may be an image to be presented over the captured images.

The operation of generating an image overlay based on the current position and the annotation object position is shown in FIG. 10 by step 905.

The operation of displaying the image overlay as and edit layer is shown in FIG. 10 by step 907.

In some embodiments the asynchronous session editor or asynchronous session viewer may furthermore be configured to be able to selectively review updates of the annotation objects. This for example may be achieved by the annotation objects being versioned and amendments identified based on a user or user device identifier. The reviewing user device may thus filter the annotation object amendments based on the user identifier or may be configured to filter the generation of the overlay image based on the user identifier.

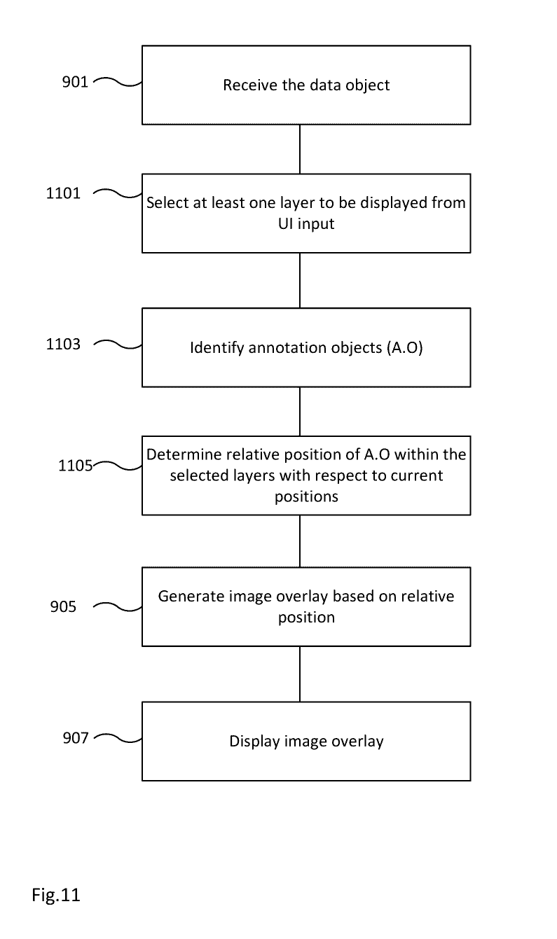

FIG. 11, for example, shows a flow diagram of a further example of the process of reviewing the asynchronous session data to selectively present an annotation object according to some embodiments.

The user device, for example the user device 102, may thus receive the asynchronous session data, comprising the video data, SR data and the annotation object data.

The operation of receiving the asynchronous session data is shown in FIG. 11 by step 901.

The user device may then be configured to determine the current position of the device. The current position of the device, for a wearable device, may be the physical position of the device in the scene. The current position of the device, in some embodiments, may be the navigation position of the device in the scene.

The operation of determining a current position of the device is shown in FIG. 11 by step 903.

The user device may then be configured to select at least one ‘edit layer’. In other words the user device may be configured to select the annotation objects which are associated with a defined user or user device and which may be logically associated together as an edit layer.

The operation of selecting at least one edit layer to be displayed is shown in FIG. 11 by step 1101.

The user device may then be configured to identify the annotation objects associated with the selected edit layer is shown in FIG. 11 by step 1103.

The user device may furthermore be configured to determine the relative position of the identified annotation objects with respect to the current position of the user device.

The operation of determining the relative position of the identified annotation objects with respect to the current position of the user device is shown in FIG. 11 by step 1105.

Having determined the relative position, the user device may furthermore in some embodiments be configured to determine an image overlay based on the relative position defined by the current position of the user device and the annotation object.

The operation of generating an image overlay based on the current position and the annotation object position is shown in FIG. 11 by step 905.

The operation of displaying the image overlay as and edit layer is shown in FIG. 11 by step 907.

In some embodiments the asynchronous session editor or asynchronous session viewer may furthermore be configured to be able to selectively indicate received updates of the annotation objects so to enable efficient monitoring of annotation objects within a scene. This for example may be achieved by generating image overlay types based on the relative distances between the device position and the annotation object position. Furthermore in some embodiments the image overlay type may furthermore indicate whether the annotation object is ‘visible’ or ‘hidden’.

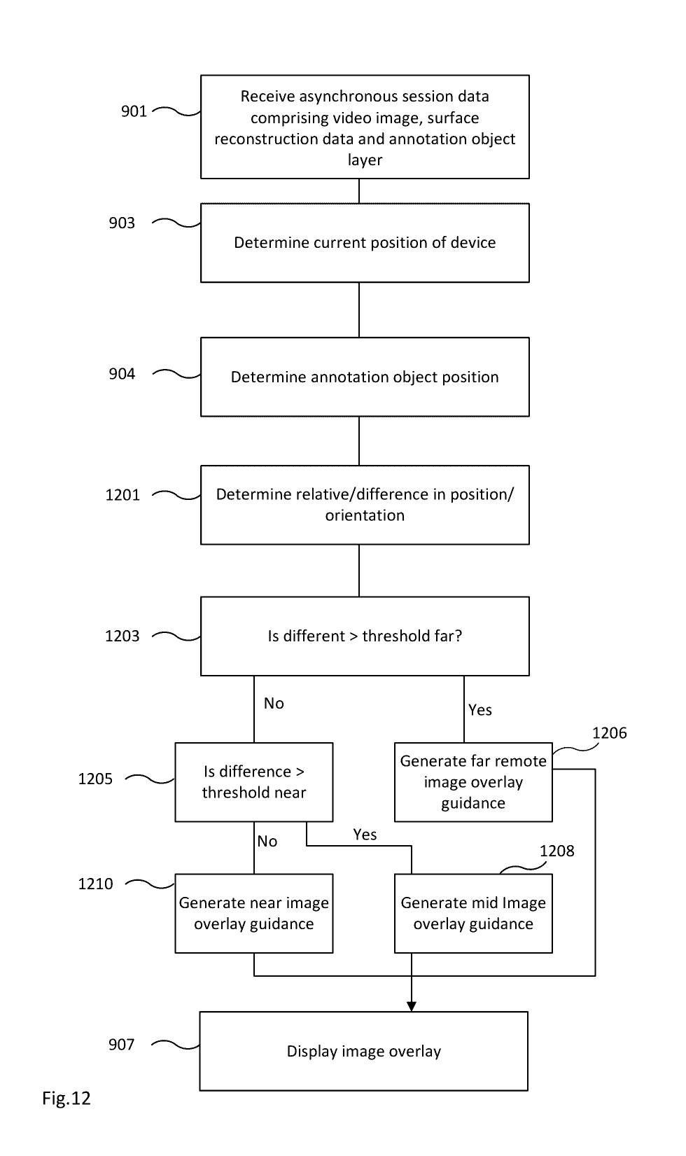

FIG. 12, for example, shows a flow diagram of a further example of the method of identifying and displaying annotation objects where different overlay types are displayed based on the ‘relative distance’ between the user device viewing the scene and the annotation object within the scene.

The user device, for example the user device 102, may thus receive the asynchronous session data comprising the video data, SR data and the annotation object data.

The operation of receiving the asynchronous session data is shown in FIG. 12 by step 901.

The user device may then be configured to determine the current position of the device. The current position of the device, for a wearable device, may be the physical position of the device in the scene. The current position of the device, in some embodiments, may be the navigation position of the device in the scene.

The operation of determining a current position of the device is shown in FIG. 12 by step 903.

The user device may furthermore be configured to determine a position of at least one of the annotation objects.

The operation of determining an annotation object position is shown in FIG. 12 by step 904.

The user device may furthermore be configured to determine the relative or difference between the annotation object position and the current position of the user device.

The operation of determining the relative/difference position is shown in FIG. 12 by step 1201.

Having determined the relative/difference between the device and object position, the user device may furthermore in some embodiments be configured to determine whether the difference is greater than a first or ‘far’ threshold.

The operation of determining whether the difference is greater than a ‘far’ threshold is shown in FIG. 1203.

Where the difference is greater than a far threshold then the user device may be configured to generate a ‘far’ image overlay based on the relative position defined by the current position of the user device and the annotation object. For example in some embodiments the image overlay may comprise a marker (for example on a compass image overlay) indicating the relative orientation and/or distance to the object.

The operation of generating a ‘far’ image overlay is shown in FIG. 12 by step 1206.

Having determined the relative/difference between the device and object position is less than the far threshold, the user device may furthermore in some embodiments be configured to determine whether the difference is greater than a second or ‘near’ threshold.

The operation of determining whether the difference is greater than a ‘near’ threshold is shown in FIG. 1205.

Where the difference is greater than a near threshold then the user device may be configured to generate a ‘mid’ image overlay based on the relative position defined by the current position of the user device and the annotation object. For example in some embodiments the image overlay may comprise a guideline (for example an arrow on the display) indicating the position of the annotation object.

The operation of generating a ‘mid’ image overlay is shown in FIG. 12 by step 1208.

Where the difference is less than a near threshold then the user device may be configured to generate a ‘near’ image overlay based on the relative position defined by the current position of the user device and the annotation object. For example in some embodiments the image overlay may comprise the annotation object representation which is highlighted (for example by a faint glow surrounding the object on the display) indicating the position of the annotation object.

The operation of generating a ‘near’ image overlay is shown in FIG. 12 by step 1210.

The operation of displaying the image overlay as an edit layer is shown in FIG. 12 by step 907.

It would be understood that as well as displaying guides for annotation object based on the distance to the object from the user device that the type of image overlay may be based on other factors such as whether the annotation object is new, whether the object has been amended recently, the ‘owner’ of the annotation object etc.

Generally, any of the functions described herein can be implemented using software, firmware, hardware (e.g., fixed logic circuitry), or a combination of these implementations. The terms “controller”, “functionality”, “component”, and “application” as used herein generally represent software, firmware, hardware, or a combination thereof. In the case of a software implementation, the controller, functionality, component or application represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

There is provided a user device within a communication architecture, the user device comprising a session viewer configured to: receive at least one annotation object associated with a mixed reality/virtual reality session; determine a field of view position; and generate an image overlay based on the determined field of view position and at least one annotation object to display an indicator to guide a user of the user device to a representation of the annotation object.

The session may be an asynchronous session.

The session viewer may be further configured to determine the difference between the field of view position and a position associated with the at least one annotation object, wherein the image overlay may be further based on the difference between the field of view position and a position associated with the at least one annotation object.

The image overlay may be a first type of image when the difference is greater than a first threshold distance, a second type of image when the difference is less than a second threshold distance and a third type of image otherwise.

The session viewer may be further configured to determine at least one attribute associated with the at least one annotation object, wherein the image overlay may be further based on the attribute.

The attribute may be the age of the at least one annotation object, wherein the image overlay may be based on the age of the annotation object.

The user device may be a wearable user device, wherein the session viewer may be configured to output the image overlay as an augmented/mixed reality image overlay.

The session viewer configured to determine a field of view position may be configured to determine camera pose information associated with the position of the wearable user device.

The session viewer may be further configured to: receive at least one image, camera pose data, and surface reconstruction data associated with the session; and generate an image based on the determined field of view position and the at least one image determined by the camera pose data to display a representation of the field of view, the image overlay being displayed over the image.

The at least one annotation object may comprise at least one of: a visual object; an audio object; and a text object.

According to another aspect there is provided a method implemented within a communication architecture, the method comprising: receiving at least one annotation object associated with a mixed reality/virtual reality session; determining a field of view position; and generating an image overlay based on the determined field of view position and at least one annotation object to display an indicator to guide a user of the user device to a representation of the annotation object.

The session may be an asynchronous session.

The method may further comprise determining the difference between the field of view position and a position associated with the at least one annotation object, wherein the image overlay may be further based on the difference between the field of view position and a position associated with the at least one annotation object.

The image overlay may be a first type of image when the difference is greater than a first threshold distance, a second type of image when the difference is less than a second threshold distance and a third type of image otherwise.

The method may further comprise determining at least one attribute associated with the at least one annotation object, wherein the image overlay may be further based on the attribute.

The attribute may be the age of the at least one annotation object, wherein the image overlay may be based on the age of the annotation object.

The method may further comprise outputting the image overlay as an augmented/mixed reality image overlay.

Determining a field of view position may further comprise determining camera pose information associated with the position of a wearable user device on which the method is implemented.

The method may further comprise: receiving at least one image, camera pose data, and surface reconstruction data associated with the session; and generating an image based on the determined field of view position and the at least one image determined by the camera pose data to display a representation of the field of view, the image overlay being displayed over the image.

A further aspect is a computer program product, the computer program product being embodied on a non-transient computer-readable medium and configured so as when executed on a processor of a protocol endpoint entity within a shared scene architecture, to: receive at least one annotation object associated with a mixed reality/virtual reality session; determine a field of view position; and generate an image overlay based on the determined field of view position and at least one annotation object to display an indicator to guide a user of the user device to a representation of the annotation object.

The session may be an asynchronous session.

The processor may be further configured to determine the difference between the field of view position and a position associated with the at least one annotation object, wherein the image overlay is further based on the difference between the field of view position and a position associated with the at least one annotation object.

The image overlay may be a first type of image when the difference is greater than a first threshold distance, a second type of image when the difference is less than a second threshold distance and a third type of image otherwise.

The processor may be further configured to determine at least one attribute associated with the at least one annotation object, wherein the image overlay may be further based on the attribute.

The attribute may be the age of the at least one annotation object, wherein the image overlay may be based on the age of the annotation object.

The processor may be configured to output the image overlay as an augmented/mixed reality image overlay.

Determining a field of view position may cause the processor to determine camera pose information associated with the position of the protocol endpoint entity.

The processor may be causes to: receive at least one image, camera pose data, and surface reconstruction data associated with the session; and generate an image based on the determined field of view position and the at least one image determined by the camera pose data to display a representation of the field of view, the image overlay being displayed over the image.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A user device within a communication architecture, the user device comprising a session viewer configured to:
receive at least one annotation object associated with a mixed reality/virtual reality session;
determine a field of view position; and
generate an image overlay based on the determined field of view position and at least one annotation object to display an indicator to guide a user of the user device to a representation of the annotation object.

2. The user device as claimed in claim 1, wherein the session is an asynchronous session.

3. The user device as claimed in claim 1, wherein the session viewer is further configured to determine the difference between the field of view position and a position associated with the at least one annotation object, wherein the image overlay is further based on the difference between the field of view position and a position associated with the at least one annotation object.

4. The user device as claimed in claim 3, wherein the image overlay is a first type of image when the difference is greater than a first threshold distance, a second type of image when the difference is less than a second threshold distance and a third type of image otherwise.

5. The user device as claimed in claim 1, wherein the session viewer is further configured to determine at least one attribute associated with the at least one annotation object, wherein the image overlay is further based on the attribute.

6. The user device as claimed in claim 5, wherein the attribute is the age of the at least one annotation object, wherein the image overlay is based on the age of the annotation object.

7. The user device as claimed in claim 1, wherein the user device is a wearable user device, wherein the session viewer is configured to output the image overlay as an augmented/mixed reality image overlay.

8. The user device as claimed in claim 1, wherein the session viewer configured to determine a field of view position is configured to determine camera pose information associated with the position of the wearable user device.

9. The user device as claimed in claim 1, wherein the session viewer is further configured to:
receive at least one image, camera pose data, and surface reconstruction data associated with the session; and
generate an image based on the determined field of view position and the at least one image determined by the camera pose data to display a representation of the field of view, the image overlay being displayed over the image.

10. The user device as claimed in claim 1, wherein the at least one annotation object comprises at least one of:
a visual object;
an audio object; and
a text object.

11. A method implemented within a communication architecture, the method comprising:
receiving at least one annotation object associated with a mixed reality/virtual reality session;
determining a field of view position; and
generating an image overlay based on the determined field of view position and at least one annotation object to display an indicator to guide a user of the user device to a representation of the annotation object.

12. The method as claimed in claim 11, wherein the session is an asynchronous session.

13. The method as claimed in claim 11, further comprises determining the difference between the field of view position and a position associated with the at least one annotation object, wherein the image overlay is further based on the difference between the field of view position and a position associated with the at least one annotation object.

14. The method as claimed in claim 13, wherein the image overlay is a first type of image when the difference is greater than a first threshold distance, a second type of image when the difference is less than a second threshold distance and a third type of image otherwise.

15. The method as claimed in claim 11, further comprises determining at least one attribute associated with the at least one annotation object, wherein the image overlay is further based on the attribute.

16. The method as claimed in claim 15, wherein the attribute is the age of the at least one annotation object, wherein the image overlay is based on the age of the annotation object.

17. The method as claimed in claim 11, further comprising outputting the image overlay as an augmented/mixed reality image overlay.

18. The method as claimed in claim 11, wherein determining a field of view position further comprises determining camera pose information associated with the position of a wearable user device on which the method is implemented.

19. The method as claimed in claim 11, further comprising:
receiving at least one image, camera pose data, and surface reconstruction data associated with the session; and
generating an image based on the determined field of view position and the at least one image determined by the camera pose data to display a representation of the field of view, the image overlay being displayed over the image.

20. A computer program product, the computer program product being embodied on a non-transient computer-readable medium and configured so as when executed on a processor of a protocol endpoint entity within a shared scene architecture, to:
receive at least one annotation object associated with a mixed reality/virtual reality session;
determine a field of view position; and
generate an image overlay based on the determined field of view position and at least one annotation object to display an indicator to guide a user of the user device to a representation of the annotation object.
